(19) United States
(12) Patent Application Publication
(10) Pub. No.: US 2010/0199869 A1
(43) Pub. Date: Aug. 12, 2010

(54) COATING FOR A PRINTING MACHINE BLANKET CYLINDER, CYLINDER WITH SUCH COATING BUILT IN, MACHINE WITH SUCH CYLINDER BUILT IN, AND METHOD FOR POSITIONING A BLANKET CYLINDER IN A PRINTING MACHINE

(76) Inventors: Roberto Levi Acobas, Milano (IT); Dario Porta, Basiglio (IT)

Correspondence Address: FITCH EVEN TABIN & FLANNERY, 120 SOUTH LASALLE STREET, SUITE 1600, CHICAGO, IL, 60603-3406, US

(21) Appl. No.: 12/668,649

(22) PCT Filed: May 28, 2008
(86) PCT No.: PCT/EP08/04244

§ 371 Date: Jan. 11, 2010

(30) Foreign Application Priority Data
Jul. 13, 2007 (IT) MI2007A001405

(51) Int. Cl. B41F 13/10; B32B 27/00; B32B 5/00; B32B 27/40; B32B 27/36; B32B 27/08

(52) U.S. Cl. 101/375; 428/411.1; 428/339; 428/423.7

(57) ABSTRACT

The coating for a printing machine blanket cylinder, comprises a multilayer structure comprising a printing blanket layer of the type suitable for the type of printing machine and an underlying elastomer layer having such physical/chemical characteristics that the body of the elastomer layer has self-levelling capacities and such thickness that combined with the thickness of the printing blanket layer it allows to maintain the desired overall thickness for the multilayer structure, a first face of the elastomer layer being integrally joined with the printing blanket layer, and a second face of the elastomer layer having a direct adhesion capacity and without requiring the interposition of additional adhesive products with the cylinder capable of adhering both in static and dynamic conditions at least sufficient to guarantee the maintenance of a perfect adhesion against the cylinder on one side and an easy removal from the same on the other.

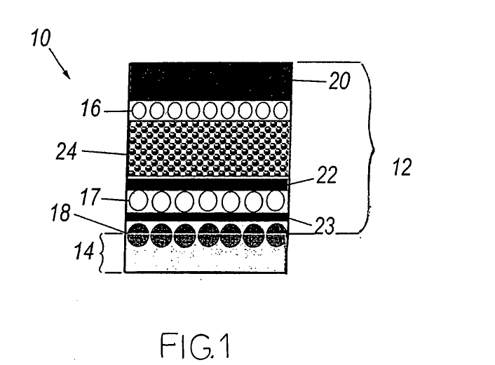

The present invention regards printing machines, especially but not exclusively of the Web Offset or Sheet Feed type. As known to the men skilled in the art, in these printing machines, mounted on the printing cylinder, made of metal and rotating around its own axis, is a coating film mainly made of rubber material—referred to as “caoutchouc” or printing blanket in the industry (hereinafter referred to as printing blanket)—which covers the side surface of the cylinder. Printing blanket is provided at its two opposite sides of a relative metal bar, usually made of aluminium or steel, having a transverse U-shaped section in such a manner to be able to be fitted onto the corresponding edge of the printing blanket and then fixed onto it. The two metal bars are used to fix the printing blanket onto the abovementioned cylinder. Traditionally, printing blanket comprises at least two layers one of which is fabric and the other is rubber, though over time printing blankets with a more complex structure have been made, comprising also more than one layer of fabric and more than one layer of rubber. The layer is for example made of cotton fabric or PET and even of metal (in particular aluminium and steel alloys), while rubber is for example of the nitrile/butyl type.

For each model of offset printing machine the manufacturer indicates the overall thickness of the coating covering the blanket cylinder. Alongside the abovementioned printing blanket (actual coating), the overall thickness of this coating is obtained also by using an undercoating (forming the so-called under-caoutchouc or underblanket, hereinafter simply referred to as underblanket) made up of a cardboard sheet and/or more and more often, of polyester. In case of polyester, the face of the underblanket intended to come into contact with the surface of the printing cylinder is treated by means of an adhesive thus, once arranged on the side surface of the printing cylinder, it remains glued against the latter. Then arranged on the underblanket is the printing blanket which is blocked against the printing cylinder by means of the abovementioned metal end bars. The thickness of the underblanket is selected in such a manner that, summed up with the one of the printing blanket, it allows to obtain the coating thickness recommended by the manufacturer of the machine.

As easily observable, the operation described above is quite long and requires attention, all this influencing the “printing machine running” costs in a substantial manner. detail: since 2006 commercial rotary offset machines were made in a way to use the standard PET (polyester) film of more than 2000 mm width-wise as an undercoating, on all printing groups. In a system, the average number of printing groups amounts to four units, corresponding to eight printing blankets. In this case, the average time required to prepare the system mounts to at least six work hours. Furthermore, when replacing the coating due to wear of the printing blanket over time, the printing blanket is removed first then followed by the underblanket. However, the adhesive which allows maintaining the printing blanket adhered against the printing cylinder remains partially stuck on the surface of the latter, hence, as well as creating difficulties for the operator, it contributes to extending the period of time required to perform the replacement operations.

Therefore, the task of the present invention is that of providing a coating, a cylinder, a printing machine and a method for setting it up capable of overcoming the drawbacks observed in the known art.

In particular, an objective of the present invention is to simplify and quicken the abovementioned replacement operation, which means a substantial reduction of costs. It should still be borne in mind that since the 70s of the last century up to date, the production of the abovementioned printing machines has increased by 4 to 20 times, due to the increased rotation speed of the printing cylinder, hence reading to a substantial reduction of the time intervals between the replacement of one printing blanket and another, therefore extending the duration of the same would be extremely well accepted by the users.

Therefore, another objective of the present invention consists in providing a coating for the printing cylinder, for the abovementioned machines, capable of lasting longer with respect to the known coatings.

Such objectives are attained through the coating complying with the independent claims provided hereinafter.

In particular, first and foremost the present invention provides for a coating for a printing machine blanket cylinder characterised in that it comprises a multilayer structure comprising a printing blanket layer of the type suitable for the type of printing machine and an underlying elastomer layer having such physical/chemical characteristics that the body of said elastomer layer is provided with self-levelling characteristics and such thickness that combined with the thickness of the printing blanket layer it allows to maintain the desired overall thickness of said multilayer structure, a first face of said elastomer layer is integrally joined to said printing blanket layer, and a second face of said elastomer layer has a direct adhesion capacity and does not require interposition of additional substances for adhesion against said cylinder both at static and dynamic conditions of said cylinder at least sufficient to guarantee the maintenance of a perfect adhesion against said cylinder on one side and an easy removal from the same on the other. Secondarily, the present invention provides for a printing machine blanket cylinder, characterised in that it comprises a coating having a multilayer structure comprising a printing blanket layer of the type suitable for the type of printing machine and an underlying elastomer layer having such physical/chemical characteristics that the body of said elastomer layer is provided with self-levelling characteristics and such thickness that combined with the thickness of the printing blanket layer it allows to maintain the desired overall thickness of said multilayer structure, a first face of said elastomer layer is integrally joined to said printing blanket layer, and a second face of said elastomer layer has a direct adhesion capacity and does not require interposition of additional substances for adhesion against said cylinder both at static and dynamic conditions of said cylinder such that the force of adherence of said elastomer layer against said cylinder proportionally corresponds to the variation of the rotational speed of said cylinder.

Thirdly, the present invention provides for a printing machine, characterised in that it comprises a blanket cylinder provided with a coating having a multilayer structure comprising a printing blanket layer of the type suitable for the type of printing machine and an underlying elastomer layer having such physical/chemical characteristics that the body of said elastomer layer is provided with self-levelling characteristics and such thickness that combined with the thickness of said printing blanket layer it allows to maintain the desired overall thickness of said multilayer structure, a first face of said elastomer layer is integrally joined to said printing blanket layer, and a second face of said elastomer layer has a direct adhesion capacity and does not require interposition of additional substances for adhesion against said cylinder both at static and dynamic conditions of said cylinder such that the force of adherence of said elastomer layer against said cylinder proportionally corresponds to the variation of the rotational speed of said cylinder.

Fourthly, the present invention provides for a method for setting-up a blanket cylinder in a printing machine, characterised in that it comprises a step of preparing a multilayer structure by joining without additional mechanical means a printing blanket layer having such physical/chemical characteristics that the body of said elastomer layer is provided with self-levelling characteristics and such thickness that combined with the thickness of the printing blanket layer it allows to maintain the desired overall thickness of said multilayer structure, and apply said multilayer structure to said cylinder by fixing directly and without interposition of additional adhesive products exploiting the surface adherence capacity of said elastomer layer at least sufficient to guarantee the maintenance of a perfect adhesion against said cylinder on one side and an easy removal from the same on the other.

Other characteristics of the present invention are described in the dependent claims.

Once again it should be observed that in the coating provided for by the present invention does not provide for the use of any adhesive between the elastomer layer and the side surface of the blanket cylinder hence eliminating the drawback (revealed, as mentioned, by the known coatings of this type) of the adhesive residues on the blanket cylinder surface.

It is to be observed that, regardless of the absence of the adhesive, due to its special physical/chemical characteristics, the coating according to the present invention does not slip on the printing cylinder, even considering the high rotational speed of the same currently provided for the abovementioned printing machines.

The slipping phenomenon, otherwise known as lateral moving, is avoided through the high mechanical grip characteristics (static and dynamic friction) of the material used. It has also been proven that the elastomer layer has also the self-levelling purpose.

Furthermore, it has been ascertained that the elastomeric layer significantly reduces penetration of washing solutions into the printing blanket fabrics. Penetration of washing solvents might lead, over time, to the separation of the layers making up the coating, side swellings with the entailed loss of printing calibration and damages on the support fabric consequently leading to structural collapse. The penetration phenomenon is accentuated when automatic printing blanket washing machines of the Baidwin/Elettra and or Oxy Dry type, for example, are used like in the case of most recent printing machines.

The close adhesion between the elastomer layer and the surface of the cylinder ensures that the latter has a protection purpose against the corrosion of the cylinder.

Also preferably, the thickness of the elastomer layer has a tolerance +/−0.01 mm.

Conveniently, the elastomer layer which forms the underblanket is mainly composed of thermoplastic polyurethane (TPU). In such case, for example, Estane composites distinguished by numbers 54660, 58437, 58070 and ETE 55DS3 produced by Noveon Inc, Cleveland, USA can be used.

The elastomer layer is applied on the internal face of the printing blanket through a process of the known type in order to obtain the thickness recommended by manufacturer of the machine and the thickness desired by the user (who can thus have a coating with a thickness customised to his specific needs).

The process of coupling the elastomer layer with the printing blanket layer can be of the mechanical type, physical and/or chemical, for example by means of flat head extrusion, calendering, spreading or other processes.

The elastomer layer can be produced and simultaneously applied on the printing blanket layer or it can be produced and subsequently coupled with the printing blanket layer.

It can be ascertained that with the thicknesses of the abovementioned elastomer comprised between 0.05 and 1.50 mm in practice it is possible to cover the entire range of market demand.

Preferably, for the coating according to the present invention the printing blanket layer has the following chemical/physical properties, in compliance with the ASTM 1894 directive:
Static friction coefficient μₛ>0.1
Dynamic friction coefficient μₖ>0.1

Such properties refer to the elastomer/steel surface.

The invention shall be easier to understand from the following description of one of its exemplifying embodiments. In such description, reference shall be made to the attached drawing, in whose sole figure schematically shown is a cross-section of a coating section according to the invention itself. As observable from the figure, the coating 10 comprises a conventional printing blanket, indicated in its entirety by 12, and an elastomer layer 14 applied onto the internal face (the one facing the blanket cylinder, not shown) of the printing blanket 12. In this illustrated specific case, the latter is made up of three fabrics 16, 17 and 18 mainly composed of cotton fibres (but, as already mentioned, they could also be made of PET fibres or carbon fibres or metal support), by an external layer 20 making up the face of the printing blanket opposite to the surface of the printing cylinder, made up conventional nitrile/butyl rubber, by two intermediate layers 22, 23 of the so-called RUBBER of the known and variable formulation, for example the one used for the printing blanket made by REEVES spa (in Lodi Vecchio—province of Lodi—Italy), currently Trelleborg Engineered Systems Italy SPA and an intermediate layer 24 still made of nitrile/butyl rubber but modified by adding an expansion agent, with closed cells (for example of the type distinguished by Expancel).

Before going on, it should be pointed out that the composition and the structure of the printing blanket 12 can be different with respect to the one just described beforehand, this depending also on the type of printing machine. Assuming a Roland Colorman or Uniman machine is used, for the newspapers, or else a Lithoman machine for commercial printing, or still otherwise a Heidelberg Speedmaster 102 machine for printing papers, depending on the model of the printing machine, the thickness of the printing blanket ranges between 1.70 and 1.95 mm. In particular regarding a Lithoman 48 pages using a 1.70 mm Vulcan Alto printing blanket model and a 0.20 mm underblanket elastomer having the abovementioned characteristics, a total thickness of 1.90 mm is obtained. According to the points argued above it is overtly clear that the removal of the coating according to the invention, once worn out, from the blanket cylinder of the abovementioned machines, as well as its replacement with a new coating are extremely simple and quick operations with respect to the conventional coatings. Furthermore, it has been ascertained that this coating lasts longer with respect to the conventional coatings.

In a possible different embodiment of the coating according to the present invention, the second face of the underlying elastomer layer composed of thermoplastic polyurethane, instead of being directly coupled to the holding cylinder, has a layer in PET both to facilitate assembly with printing blanket and to facilitate the subsequent application of the so obtained assembly on the holding cylinder.

The coating for printing machines thus conceived is susceptible to various modifications and variants, all falling within the invention concept; furthermore, all details can be replaced by other technically equivalent elements. In practice, the material used, alongside the dimensions, may vary depending on the requirements and the state of art.

1. Coating for a printing machine blanket cylinder, comprising a blanket layer and an underlying elastomer layer having such physical/chemical characteristics that said elastomer layer has self-levelling capacities and such thickness that combined with the thickness of said printing blanket layer it allows to maintain the desired overall thickness for said coating, a first face of said elastomer layer is integrally joined with said printing blanket layer, and a second face of said elastomer layer has a direct adhesion capacity and does not require interposition of additional adhesive products with said cylinder capable of adhering both in static and dynamic conditions at least sufficient to facilitate the maintenance of a perfect adhesion against said cylinder on one side and an easy removal from the same on the other.

2. Coating for a printing machine blanket cylinder according to claim 1, wherein said first face of said elastomer layer is directly connected to said printing blanket layer.

3. Coating for a printing machine blanket cylinder according to claim 1, wherein said first face of said elastomer layer is connected to said printing blanket layer by means of interposition of an adhesive product.

4. Coating for a printing machine blanket cylinder according to claim 1, wherein said elastomer layer has properties to protect against the corrosion of said cylinder.

5. Coating for a printing machine blanket cylinder according to claim 1, wherein said elastomer layer has a thickness ranging between 0.05 and 1.50 mm.

6. Coating for a printing machine blanket cylinder according to claim 1, wherein the thickness of said elastomer layer has a tolerance of +/−0.01 mm.

7. Coating for a printing machine blanket cylinder according to claim 1, wherein said elastomer layer is made of thermoplastic polyurethane.

8. Coating for a printing machine blanket cylinder according to claim 1, wherein said elastomer layer is produced and simultaneously coupled with said printing blanket layer.

9. Coating for a printing machine blanket cylinder according to claim 1, wherein said elastomer layer is produced and subsequently coupled with said printing blanket layer.

10. Coating for a printing machine blanket cylinder according to claim 1, wherein said printing blanket layer, referring to the elastomer/steel surface, has a static friction coefficient μₛ>0.1 and a dynamic friction coefficient μₖ>0.1.

11. Coating for a printing machine blanket cylinder according to claim 1, wherein the face facing said cylinder of said elastomer layer has a special surface finishing.

12. Coating for a printing machine blanket cylinder, comprising a printing blanket layer and an underlying elastomer layer made of thermoplastic polyurethane having such physical/chemical characteristics that the body of said elastomer layer has self-levelling capacities and such thickness that combined with the thickness of said printing blanket layer it allows to maintain the desired overall thickness for said coating, a first face of said elastomer layer is integrally joined with said printing blanket layer, and a second face of said elastomer layer has a layer in PET both to facilitate assembly with said printing blanket and to facilitate the subsequent application of the so obtained assembly on said cylinder.

13. Blanket cylinder for a printing machine with a coating having a multilayer structure comprising a printing blanket layer and an underlying elastomer layer having such physical/chemical characteristics that the body of said elastomer layer is provided with self-levelling characteristics and such thickness that combined with the thickness of the printing blanket layer it allows to maintain the desired overall thickness of said multilayer structure, a first face of said elastomer layer is integrally joined to said printing blanket layer, and a second face of said elastomer layer has a direct adhesion capacity and does not require interposition of additional products for adhesion against said cylinder both at static and dynamic conditions of said cylinder such that the force of adherence of said elastomer layer against said cylinder proportionally corresponds to the variation of the rotational speed of said cylinder.

14. (canceled)

15. Method for setting-up a blanket cylinder in a printing machine, wherein a step of preparing a multilayer structure by joining without additional mechanical means a printing blanket layer having such physical/chemical characteristics that the body of said elastomer layer is provided with self-levelling characteristics and such thickness that combined with the thickness of the printing blanket layer it allows to maintain the desired overall thickness of said multilayer structure, and apply said multilayer structure to said cylinder by fixing directly and without interposition of additional adhesive products exploiting the surface adherence capacity of said elastomer layer at least sufficient to facilitate the maintenance of a perfect adhesion against said cylinder on one side and an easy removal from the same on the other.

16. Blanket cylinder for a printing machine of claim 13, in combination with a printing machine.
